(19) United States
(12) Patent Application Publication
(10) Pub. No.: US 2008/0263852 A1
(43) Pub. Date: Oct. 30, 2008

(54) METHOD FOR FORMING SLOT ON SUBSTRATE AND STRUCTURE THEREOF

(75) Inventors: Shih-ching Chang, Kaohsiung City (TW); Kuang-chun Chou, Kaohsiung City (TW); Wu-chang Wang, Kaohsiung City (TW)

Correspondence Address: MADSON & AUSTIN, 15 WEST SOUTH TEMPLE, SUITE 900, SALT LAKE CITY, UT, 84101, US

(73) Assignee: Advanced Semiconductor Engineering, Inc.

(21) Appl. No.: 12/108,040

(22) Filed: Apr. 23, 2008

(30) Foreign Application Priority Data
Apr. 27, 2007 (TW) 096115159

(51) Int. Cl. B23P 13/04

(52) U.S. Cl. 29/558

(57) ABSTRACT

A method for forming a slot on a substrate is disclosed, and provides a two-step process used to firstly form two circular holes on two ends of a predetermined cut area and then form a rectangular hole between the two circular holes by punching. Thus, the friction generated between a punching machine and the substrate during punching can be lowered, so as to prevent glass fiber layers of the substrate from being peeled off, avoid the glass fiber layers from forming burrs, and prevent a metal trace layer of the substrate from being peeled off. Meanwhile, because a portion of the substrate having the metal trace layer is not processed by a milling process, it can prevent the metal trace layer from forming metal burrs.

### FIELD OF THE INVENTION

The present invention relates to a method for forming a slot on a substrate and a structure thereof, and more particularly to a method for forming a slot on a substrate and a structure of the substrate having the slot formed by a two-step process.

### BACKGROUND OF THE INVENTION

Traditionally, a substrate, such as a substrate of a BOC (Board-On-Chip) package, can be processed to form a slot by a milling cutter (i.e. a boring tool). However, a cutting process utilizing the milling cutter may cause some problems. For example, the yield of the substrate (per unit time) is relatively low; the manufacture cost of the substrate is relatively high; the slot on the substrate may be formed with metal burrs, and etc. Alternatively, the slot can be formed by one-step punching. However, the substrate with the slot formed by punching still has some disadvantages. For example, glass fiber layers of the substrate is easily peeled off; a metal trace layer (golden fingers) on the substrate is easily peeled off; the glass fiber layers may be exposed in the slot to form burrs; the manufacture cost of punching molds is relatively high, and etc.

Referring now to FIG. 1, a traditional method for forming a slot on a substrate is illustrated. As shown, a substrate 10 is formed with a slot 12 which can be separated into two curved portions 11 and a rectangular portion 13. The substrate 10 has a plurality of metal pads 14 (i.e. golden fingers) adjacent to two side edges of the rectangular portion 13. In the traditional method for forming the slot 12 of the substrate 10, if the slot 12 is cut by a milling cutter, inner end edges of the metal pads 14 (corresponding to the rectangular portion 13) may be easily formed with metal burrs during milling. Meanwhile, the manufacture cost of the slot 12 formed by milling is relatively high, and the yield of the substrate (per unit time) is relatively low. On the other hand, the slot 12 can be formed by one-step punching. However, because friction is generated between punching molds and a work-piece (i.e. the substrate 10), it is easy to peel off the glass fiber layers from inner edges of the curved portions 11, or to form burrs on the inner edges thereof. Furthermore, inner end edges of the metal pads 14 (corresponding to the rectangular portion 13) may be easily peeled off. Moreover, the one-step punching method for forming the slot 12 further needs an optical projection grinder, while related molds are expensive, resulting in increasing the manufacture cost of the substrate 10.

As a result, it is necessary to develop a technological solution to solve the foregoing problems existing in the traditional method for forming the slot 12 of the substrate 10.

### SUMMARY OF THE INVENTION

A primary object of the present invention is to provide a method for forming a slot on a substrate and a structure of the substrate having the slot, wherein the substrate is formed with the slot by a two-step process, so as to enhance the product quality of the substrate and lower the manufacture cost thereof.

To achieve the above object, the method for forming a slot on a substrate according to a preferred embodiment of the present invention comprises steps of:

providing a substrate having a plurality of metal pads which are arranged into at least one row;
forming two circular holes on a predetermined cut area of the substrate by two hole manufacturing devices, wherein the two circular holes are formed adjacent to two outermost metal pads of the at least one row of the metal pads, respectively; and
forming a rectangular hole between the two circular holes on the substrate by punching, wherein the rectangular hole has two ends overlapped with the two circular holes, respectively, so as to form a slot on the substrate.

In an embodiment of the present invention, the step of forming the two circular holes can be carried out by a milling process (i.e. a boring process) or a punching process. If the step is carried out by the milling process, the hole manufacturing devices can be selected from milling cutters (i.e. boring tools). Alternatively, if the step is carried out by the punching process, the hole manufacturing devices can be selected from circular punches.

In an embodiment of the present invention, the rectangular hole has a width slightly smaller than a diameter of the two circular holes, so as to lower the friction between a punch and the substrate.

In an embodiment of the present invention, the step of forming the rectangular hole by punching further comprises a step of: injecting a high-pressure gas to press the metal pads when a punch for the punching process is elevated, so as to prevent the metal pads from being peeled off.

In an embodiment of the present invention, the metal pads are arranged into two rows corresponding to each other.

In an embodiment of the present invention, the substrate having the slot comprises a slot including two circular holes and a rectangular hole. The substrate has a plurality of metal pads which are arranged around the slot. The two circular holes are formed on two ends of the slot, respectively, and selectively processed by a milling process or a punching process. The rectangular hole processed by another punching process is formed between the two circular holes, and overlapped with the two circular holes. Furthermore, the rectangular hole has a width slightly smaller than a diameter of the two circular holes, so as to lower the friction between a punch and the substrate during punching. The metal pads on the substrate are selectively arranged into two rows corresponding to each other. The rectangular hole is surrounded by the two rows of the metal pads and the two circular holes.

In comparison with prior art, a method for forming a slot on a substrate and a structure of the substrate having the slot according to a preferred embodiment of the present invention provides a two-step process used to firstly form two circular holes on two ends of the predetermined cut area and then form a rectangular hole between the two circular holes by punching, so as to be advantageous to lower the friction generated between a punching machine and the substrate during punching, prevent the glass fiber layers from being peeled off, avoid the glass fiber layers from forming burrs, and prevent the metal trace layer (i.e. metal pads) from being peeled off. Meanwhile, because a portion of the substrate having the metal trace layer is not processed by a milling process, it can prevent the metal trace layer from forming metal burrs. As a result, according to the method of the present invention, the yield of the substrate (per unit time) and the product quality thereof can be increased, while it is unnecessary to process the substrate by an expensive optical projection grinder and related mold equipments, so as to lower the manufacture cost of the substrate.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic view of a traditional method for forming a slot on a substrate;

FIG. 2A is a vertical view of two hole manufacturing devices for a milling process according to a preferred embodiment of the present invention;

FIG. 2B is a vertical view of a substrate formed with two circular holes by the two hole manufacturing devices according to the preferred embodiment of the present invention;

FIG. 3 is a schematic view of a punching machine for a punching process according to the preferred embodiment of the present invention;

FIG. 4A is a vertical view of a punch of the punching machine according to the preferred embodiment of the present invention; and

FIG. 4B is a vertical view of the substrate formed with a rectangular hole by the punch according to the preferred embodiment of the present invention.

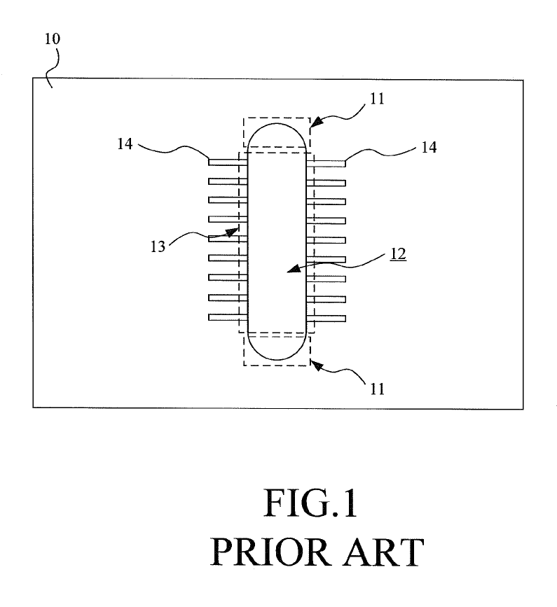

### DETAILED DESCRIPTION OF THE PREFERRED EMBODIMENTS

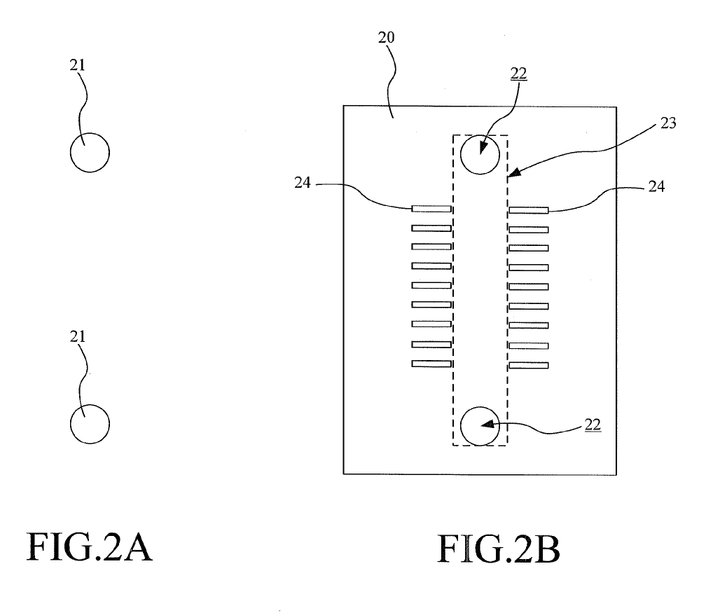

Referring now to FIGS. 2A and 2B, a vertical view of two hole manufacturing devices for a milling process and a vertical view of a substrate formed with two circular holes by the two hole manufacturing devices according to a preferred embodiment of the present invention are illustrated, respectively. As shown, according to a method for forming a slot on a substrate in the preferred embodiment of the present invention, two hole manufacturing devices 21 are firstly provided to form two circular holes 22 on two ends of a predetermined cut area 23 of a substrate 20. The substrate 20 has a plurality of metal pads 24 adjacent to the cut area 23, wherein the metal pads 24 are arranged into two rows corresponding to each other. Furthermore, the circular holes 22 can be formed by a milling process or a punching process. If the circular holes 22 are formed by the milling process, the two hole manufacturing devices 21 are selected from milling cutters of a milling machine. Alternatively, if the circular holes 22 are formed by the punching process, the two hole manufacturing devices 21 are selected from circular punches of a punching machine.

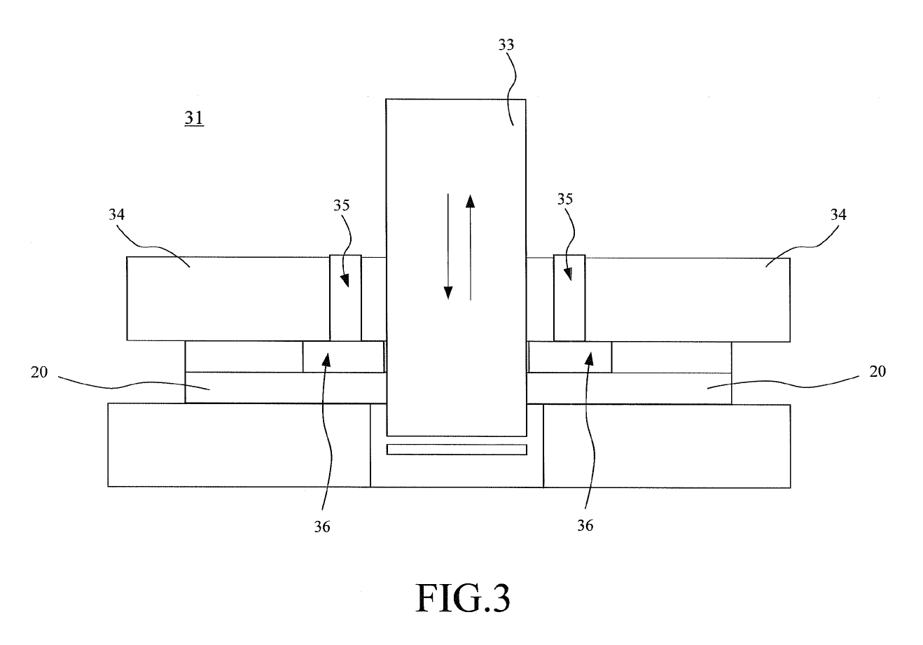

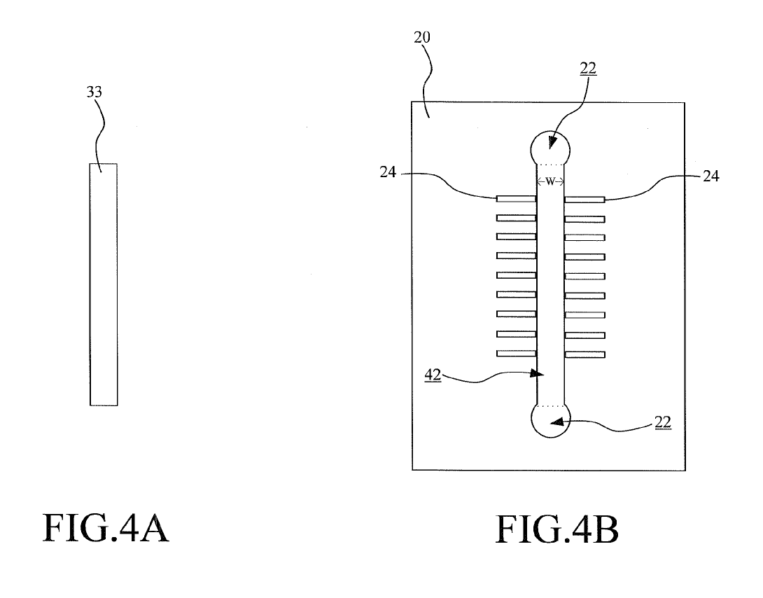

Referring now to FIGS. 3, 4A, and 4B, a schematic view of a punching machine, a vertical view of a punch of the punching machine, and a vertical view of the substrate formed with a rectangular hole by the punch according to the preferred embodiment of the present invention are illustrated, respectively. After forming the circular holes 22, the substrate 20 is then placed on a punching machine 31 for executing a punching process. After positioning the substrate 20 on the punching machine 31, a punch 33 of the punching machine 31 is used to form a rectangular hole 42 between the two circular holes 22 on the substrate 20, and the rectangular hole 42 is surrounded by the two rows of the metal pads 24. Meanwhile, the rectangular hole 42 has two ends overlapped with the two circular holes 22. As shown in FIG. 3, the punch 33 can be shifted along directions indicated by two arrows. After processing, the rectangular hole 42 can be communicated with the two circular holes 22, so as to form a slot. During punching, the punching machine 31 has a stripper 34 formed with two high-pressure gas inlets 35 which can be used to inject high-pressure gas into a high-pressure gas space 36 when the punch 33 is elevated. Thus, the metal pads 24 on the substrate 20 can be pressed by the high-pressure gas, so as to prevent the metal pads 24 from being peeled off. Moreover, when the rectangular hole 42 is formed by the punching process, the predetermined cut area 23 of the substrate 20 formed with the rectangular hole 42 has two ends including the two circular holes 22. Thus, when the punch 33 is elevated, it can prevent from generating tight friction between the punch 33 and the substrate 20, so as to avoid the metal pads 24 or the glass fiber layers (not shown) of the substrate 20 from being peeled off, and prevent the glass fiber layers from forming burrs. Meanwhile, because a portion of the substrate 20 having the metal pads 24 is not processed by any milling process, it can prevent the metal pads 24 from metal burrs.

Referring still to FIGS. 4A and 4B, in the preferred embodiment of the present invention, because the width W of the rectangular hole 42 is slightly smaller than the diameter of the two circular holes 22, the precision of positioning the rectangular hole 42 and the two circular holes 22 can be easily controlled, and the friction between the punch 33 and the substrate 20 can be relatively lowered. Preferably, the width W of the rectangular hole 42 is slightly smaller than the diameter of the two circular holes 22 about 0.05 mm.

As described above, in comparison with prior art, a method for forming a slot on a substrate and a structure of the substrate having the slot according to a preferred embodiment of the present invention provide a two-step process used to firstly form the two circular holes 22 on two ends of the predetermined cut area 23 and then form the rectangular hole 42 between the two circular holes 22 by punching, so as to be advantageous to lower the friction generated between the punching machines and the substrate 20 during punching, prevent the glass fiber layers from being peeled off, avoid the glass fiber layers from forming burrs, and prevent the metal trace layer (i.e. the metal pads 24) from being peeled off. Meanwhile, because a portion of the substrate 20 having the metal trace layer is not processed by a milling process, it can prevent the metal trace layer from forming metal burrs. As a result, according to the method of the present invention, the yield of the substrate 20 (per unit time) and the product quality thereof can be increased, while it is unnecessary to process the substrate 20 by an expensive optical projection grinder and related mold equipments, so as to lower the manufacture cost of the substrate 20.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A method for forming a slot on a substrate, comprising:
providing a substrate having a plurality of metal pads and a predetermined cut area, wherein the metal pads are arranged around the predetermined cut area;
forming two circular holes on the predetermined cut area of the substrate; and
forming a rectangular hole between the two circular holes on the substrate by a punching process, wherein the rectangular hole has two ends overlapped with the two circular holes, respectively, so as to form a slot on the substrate.

2. The method as claimed in claim 1, wherein the step of forming the two circular holes is carried out by a milling process using milling cutters.

3. The method as claimed in claim 1, wherein the step of forming the two circular holes is carried out by a punching process using punches.

4. The method as claimed in claim 1, wherein the rectangular hole has a width smaller than a diameter of the two circular holes.

5. The method as claimed in claim 4, wherein the width of the rectangular hole is smaller than the diameter of the two circular holes about 0.05 mm.

6. The method as claimed in claim 1, wherein the step of forming the rectangular hole by the punching process further comprises: injecting a high-pressure gas to press the metal pads when a punch for the punching process is elevated.

7. The method as claimed in claim 1, wherein the metal pads are arranged into two rows corresponding to each other.

8. A substrate, comprising:
a slot;
a plurality of metal pads arranged around the slot;
two circular holes formed on two ends of the slot; and
a rectangular hole formed between the two circular hole, and overlapped with the two circular holes, so as to form the slot;
wherein the rectangular hole has a width smaller than a diameter of the two circular holes.

9. The substrate as claimed in claim 8, wherein the metal pads are arranged into two rows corresponding to each other, the rectangular hole is between the two circular holes on the substrate, and the rectangular hole is surrounded by the two rows of the metal pads and the two circular holes.

10. The substrate as claimed in claim 8, wherein the width of the rectangular hole is smaller than the diameter of the two circular holes about 0.05 mm.
